(19) United States
(12) Patent Application Publication
(10) Pub. No.: US 2023/0388587 A1
(43) Pub. Date: Nov. 30, 2023

(54) PROGRAM, TERMINAL DEVICE, AND METHOD

(71) Applicant: THEATER GUILD INC., Tokyo (JP)

(72) Inventor: Sotaro IGARASHI, Tokoyo (JP)

(73) Assignee: THEATER GUILD INC., Tokyo (JP)

(21) Appl. No.: 18/248,509

(22) PCT Filed: Jul. 16, 2021
(86) PCT No.: PCT/JP2021/026846

§ 371 Date: Apr. 10, 2023

(30) Foreign Application Priority Data
Oct. 14, 2020 (JP) 2020-172943

(51) Int. Cl. H04N 21/442; H04N 21/475; H04N 21/4415

(52) U.S. Cl. CPC H04N 21/44218; H04N 21/4753; H04N 21/4415

(57) ABSTRACT

The terminal device 10 of a screen presentation system 1 comprises: a connection detection unit 152 for detecting the connection of the terminal device to a display device; a photographing control unit 153 for controlling the photographing of a viewer by a camera 130; a viewer state information acquisition unit 155 for detecting the state of the viewer and acquiring as information that indicates the state of the viewer; and a video display control unit 157 for presenting the video to the display device.

### BACKGROUND ART

Conventionally, the distribution of video content via the communication networks such as the internet has been performed by several video distributors.

Patent document 1 discloses a technology for distributing digital video, interactive data such as internet data, and conventional telephone services (POTS). This technology provides multiple video channels and interactive data via communication lines, and manages access privileges and account status to prevent unauthorized use.
Patent Document 1: JP-A-2003-521130

### SUMMARY

### Technical Problem

By the way, when streaming video content, it is important to prevent unauthorized use and ensure collection of viewing fees. It is also important to make the system easy to use, without requiring complicated setup work. As described above, technology for a video distribution system that prevents unauthorized use and enables easy use has been desired.

Thus, this disclosure describes a technology for a video distribution system that prevents unauthorized use and is easy to use.

### Solution to Problem

According to one embodiment of the disclosure, a program for execution by a computer provided with a processor and connected to a display device displaying video, wherein the program is configured to cause the processor to execute a step of detecting the connection of the terminal device to the display device; a step of capturing a viewer viewing the video displayed on the display device and generating the captured image information; a step of acquiring information indicating a state of the viewer based on the captured image information; and a step of receiving image information related to the image delivered from an external source based on the information indicating the state of the viewer, and displaying the image on the said display device.

According to another embodiment of the disclosure, a terminal device connected to a display device displaying video comprising a control unit and a photographing unit; wherein the photographing unit captures an image of a viewer viewing the video displayed on the display device and generates captured image information; and wherein the control unit executes a step of detecting the connection of the terminal device to the display device; a step of acquiring information indicating a state of the viewer based on the captured image information; and a step of receiving video information distributed from an external source and displaying the video on the display device based on the state of the viewer.

According to another embodiment of the disclosure, a method for execution by a computer provided with a processor and connected to a display device displaying video, wherein the method comprises a processor executing a step of detecting the connection of the terminal device to the display device; a step of capturing a viewer viewing the video displayed on the display device and generating the captured image information; a step of acquiring information indicating a state of the viewer based on the captured image information; and a step of receiving video information distributed from an external source and displaying the video on the display device on the state of the viewer.

According to the present disclosure, when the system detects that the terminal device is connected to a display device, the terminal device takes a picture of the viewer viewing the video, acquires information indicating the viewer's status, and the system displays the video on the display device. This prevents unauthorized use and makes it possible to construct a video distribution system which is easy to use.

### FIGURES

FIG. 1: Overall structure of the screen presentation system 1 of the Embodiment 1.

FIG. 2: Perspective view showing the external appearance of terminal devices comprising the screen presentation system 1 of the Embodiment 1.

FIG. 3: Front view showing the state of the terminal device 10 comprising the screen presentation system 1 of the Embodiment 1 connected to the TV 40.

FIG. 4: A block diagram showing the functional configuration of the terminal device 10 comprising the screen presentation system 1 of the Embodiment 1.

FIG. 5: A diagram showing the functional configuration of the server 20 comprising the screen presentation system 1 of the Embodiment 1.

FIG. 6: A diagram showing the data structure of the viewer database 2021, the equipment database 2022, and the viewing purchase database 2023 stored by the server 20.

FIG. 7: A flowchart showing an example of the flow of the process for accepting applications to view a video by the screen presentation system 1 of the Embodiment 1.

FIG. 8: A flowchart showing an example of the flow of the process for screening videos by the screen presentation system 1 of the Embodiment 1.

FIG. 9: A diagram showing an example of a screen displaying application information on a user terminals 30 in the video viewing the application acceptance process.

FIG. 10: A diagram showing an example of the viewer's state as filmed by the camera 130 of the terminal device 10 in the video screening process.

FIG. 11: A diagram showing the functional configuration of the server 20 comprising the screen presentation system 1 of the Embodiment 2.

FIG. 12: A flowchart showing an example of the flow of the process for screening videos by the screen presentation system 1 of the Embodiment 2.

FIG. 13: A diagram showing the functional configuration of the server 20 comprising the screen presentation system 1 of the Embodiment 3.

### DETAILED DESCRIPTION

The following is a description of the Embodiment of the present disclosure with reference to the drawings. In the following description, identical components are marked with the same symbol. Their names and functions are also the same. Therefore, a detailed explanation of them is not repeated.

### Overview

The following describes a screen presentation system of the present disclosure. The screen presentation system is a system for screening (displaying) various types of images, such as film contents, broadcast images of sports events, concerts, talk events, etc., on display devices such as television receivers (including smart TVs with information processing functions), displays and projectors installed in private homes, shops, offices, etc. This is a system for screening (displaying) various types of images, such as movie-like image content, live broadcast images of sports events, concerts, talk events, etc., and classroom images for educational use. The screening (display) of various types of video can be either real-time filmed and distributed (so-called live relay) or recorded. Furthermore, the images may be available for viewing only at predetermined times, or at arbitrary times.

In this screen presentation system, for example, the program contents, distribution dates and times, viewing fees, etc., of the various videos described above are indicated on a web page provided by a company operating the screen presentation system. Users (viewers) who wish to view these various videos access the web pages provided by the operators of the screen presentation system from their own mobile terminals such as smartphones and tablets or PCs (Personal Computer), select the video they wish to view, and make an application to view the video. At this time, the user purchases the right to view the video in the form of a ticket using various payment methods (e.g., cashless payment by credit card, prepaid card, debit card, etc., or payment by various means of remittance). At the predetermined delivery date and time, at the server of the operator, the user is authenticated as the legitimate right holder, i.e., the person who purchased the ticket, by means of a predetermined authentication, and the distribution of the video is started.

In order to provide such screen presentation system, a dongle-type terminal device is provided in this screen presentation system. This terminal device is sent and rented (or may be transferred) by the operator when the user applies to view the images and purchases the ticket. When the terminal device it connected to a display device such as a television receiver or display, the terminal device communicates with the operator's server to receive the various types of images and displays on the display device. Therefore, this terminal device is therefore provided with connection ports to display devices, such as a USB (Universal Serial Bus) port, an HDMI (High-Definition Multimedia Interface) (registered trademark) port, a VGA (Video Graphics Array) port, and Video Graphics Array) port.

The terminal device is not necessarily be sent each time a user makes an application for video viewing. The terminal device sent once to the user may be used repeatedly. According to this configuration, the user only required to connect the dongle-type terminal device to the display device to view the video.

The terminal device is also provided with a camera. When the terminal device is connected to the display unit, the camera filming the surroundings the user (usually a viewer in front of the display unit). This screening system authenticates that the user is legitimate. The authentication is based on determining, in the captured image information taken by the camera, whether the user in the camera is a user with legitimate rights who has purchased a ticket to view the video, and whether the number of users specified when the user purchased a ticket (whether there are more than the specified number of users in the image) is in the image. The terminal device then starts showing (displaying) the video only when the authentication use is completed. This configuration makes it possible to distribute images to legitimate users.

### Embodiment 1

The screen presentation system 1 is described below. In the following description, for example, when a terminal device 10 accesses a server 20, the server 20 responds with information to the terminal device 10. Also, when a user terminals 30 accesses the server 20, the server 20 responds with information for generating a screen at the user terminals 30. The user terminals 30 generates and displays a screen based on the information received from the server 20.

<1. Overall Configuration of Screen Presentation System 1>

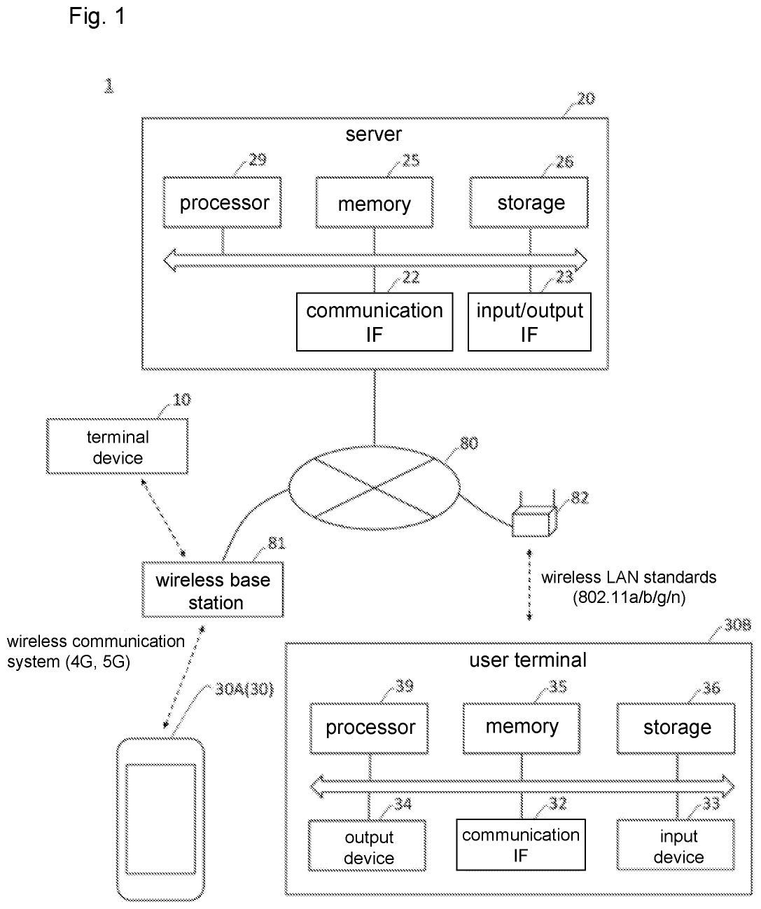

FIG. 1 shows the overall structure of the screen presentation system 1. As shown in FIG. 1, the screen presentation system 1 includes the terminal device 10, the server 20 and a plurality of user terminals (in FIG. 1, user terminal 30A and user terminal 30B are shown. Hereinafter collectively referred to as “user terminal 30”). The terminal device 10, the server 20 and the user terminals 30 are mutually communicably connected via the network 80. The network 80 comprises a wired or wireless network.

The terminal device 10 is a dongle-type terminal device for providing screening of video images. A user is, for example, a person who wishes to view or is viewing various images by the screen presentation system 1, and who uses a display device such as a television receiver or a display. The appearance and use of the terminal device 10 is described below.

The terminal device 10 is communicatively connected to the server 20 via the network 80. The terminal device 10 is connected to the network 80 by communicating with communication devices such as a wireless base station 81 compatible with communication standards such as 4G, 5G and LTE (Long Term Evolution), a wireless LAN (Local Area) such as IEEE (Institute of Electrical and Electronics Engineers) 802.11 Network) standards, such as IEEE (Institute of Electrical and Electronics Engineers) 802.11, and a wireless LAN (Local Area Network) router 82, which is connected to the network 80.

The server 20 is a device that manages user information and video distribution and is managed by the operator of the screen presentation system 1. The server 20 accepts applications for video viewing through operations by users from user terminal 30. The server 20 also performs the prescribed authentication for the user and transmits the video information to allow legitimate users to view the video.

The server 20 is a computer connected to network 80. The server 20 has a communication IF (interface) 22, an input/output IF 23, a memory 25, a storage 26 and a processor 29.

The communication IF 22 is an interface for the server 20 to communicate with external devices and to input and output signals. The input/output IF 23 functions as an interface with input devices for receiving input operations from the operator (operator) and output devices for presenting information to the operator. The memory 25 is for temporarily storing programs, and data and other data processed by the programs, and is a volatile memory such as DRAM (Dynamic Random Access Memory), for example. The storage 26 is a storage device for storing data, e.g., flash memory, HDD (Hard Disc Drive). The processor 29 is hardware for executing the instruction set described in the program and comprises arithmetic units, registers, peripheral circuits.

The user terminals 30 are a device operated by each user. As shown in FIG. 1 as user terminal 30A, user terminals 30 is a smartphone, tablet, or other terminal device compatible with the mobile communication system. In addition, the user terminal 30 may also be a stationary PC (Personal Computer) or a laptop PC, for example.

The user terminal 30 is communicatively connected to the server 20 via the network 80. The user terminals 30 are connected to the network 80 by communicating with communication devices such as a wireless base station 81 compatible with communication standards such as 4G, 5G and LTE, and a wireless LAN router 82 compatible with wireless LAN standards such as IEEE 802.11. As shown in FIG. 1 as user terminals 30B, user terminal is equipped with a communication IF 32, an input device 33, an output device 34, a memory a storage unit 36 and a processor 39.

The communication IF 32 is an interface for inputting and outputting signals in order for the user terminal 30 to communicate with external devices. The input device 33 is the device (e.g., touch panel, touch pad, pointing device such as a mouse, keyboard, etc.) for receiving input operations from the user. The output device 34 is the device (e.g., display, speaker, etc.) for presenting information to the user. Memory 35 is for temporarily storing programs and data and the like processed by the programs and the like, e.g., volatile memory such as DRAM. Memory 36 is a storage device for storing data, e.g., flash memory, HDD (Hard Disc Drive). Processor 39 is hardware for executing the instruction set described in the program and comprises arithmetic units, registers, peripheral circuits, etc.

<1.1. Configuration of the Terminal Device 10>

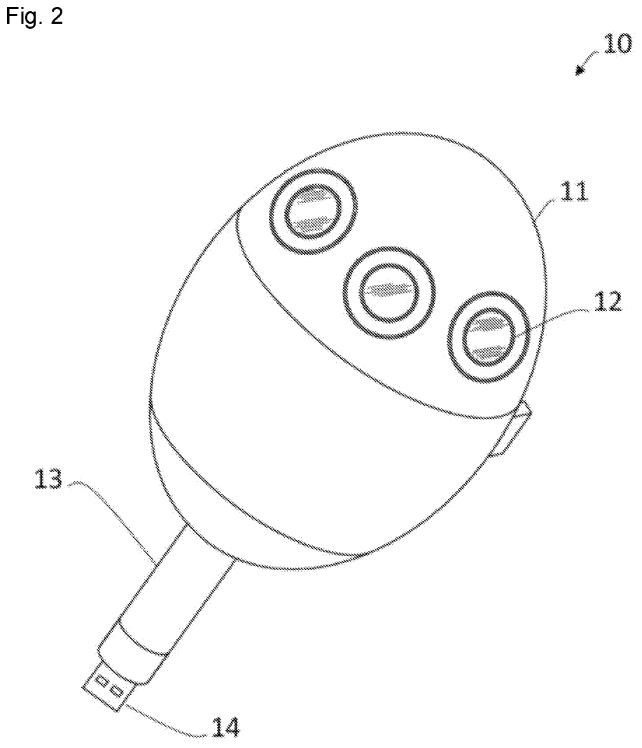

FIG. 2 shows a diagrammatic view of the terminal device 10 comprising the screen presentation system 1 of the Embodiment 1. As shown in FIG. 2, the terminal device 10 comprises a body 11, a window 12, a support 13 and a connector 14.

The body 11 is a housing for storing various devices for realizing the functions provided by the terminal device 10. The shape of the body 11 is not limited to an oval body as shown in FIG. 2 but can be any shape that can store various devices. The shape of the body 11 may be large enough to store a camera 130, as described below, and large enough to be connected to the TV 40 and not obstruct the surrounding area.

The window 12 is provided to enable the camera 130, described below, to photograph the surroundings of the terminal device 10. The support 13 is a protruding portion provided to prevent the terminal device 10 from crashing when connected to the TV 40 described below. The support 13 may be configured to be refractile by a material whose shape can be changed in order to support the body 11 stably when connected to the TV 40. The connector 14 is a connection port for connecting to the TV 40, which is described below, and comprises a USB port, an HDMI port, a VGA port or the like.

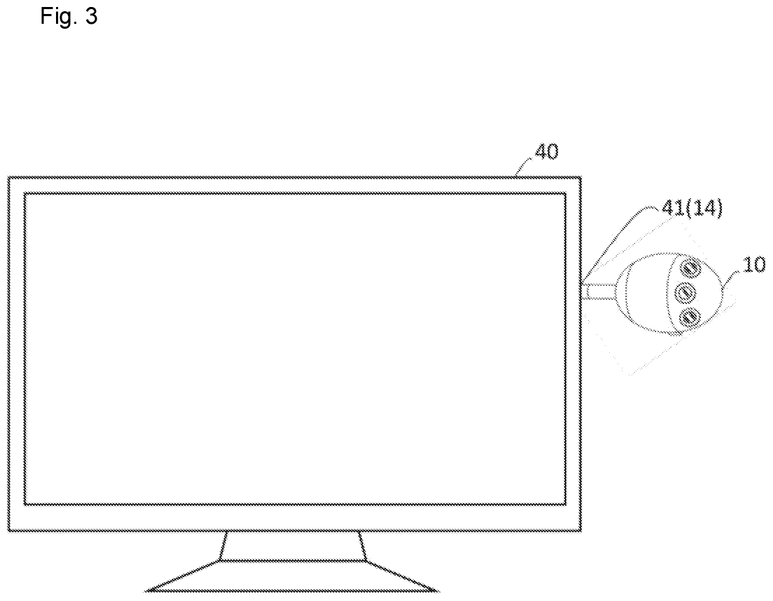

FIG. 3 shows a front view of the terminal device 10 comprising the screen presentation system 1 of the Embodiment 1 connected to a television 40. As shown in FIG. 3, the terminal device 10 is used connected to a television 40, which is an example of a display device, to screen (display) various images on the television 40. The television 40 shown in FIG. 3 is, for example, a liquid crystal television and is provided with an external connection terminal 41 for receiving video signals, etc. from external source. The external connection terminal 41 comprises a USB port, an HDMI port, a VGA port, etc.

As shown in FIG. 3, the terminal device 10 receives video information transmitted from the server 20 by connecting the connector 14 to the external connection port 41 of the television 40 and shows (displays) various images as video on the television 40. In addition, the camera 130 provided inside the body 11 photographs the surroundings through the window 12. If the support 13 is efractile, it may be refracted so that the body 11 is directed upwards. The terminal device 10 may be configured to operate by receiving power from the television 40 or may be configured to operate by receiving power from a battery or an external power supply. In this Embodiment, the television 40 is shown as an example of a display device to which the terminal device 10 is connected, but it may be configured to be connected to a projector that shows images on an LCD panel, display, screen, or the like. It may also be configured to have more than one display device (TV, LCD panel or screen) displaying images and to display different images on each display device. In such a case, the terminal device 10 may be configured to connect to a control unit or the like that controls the display of images on the plurality of display devices.

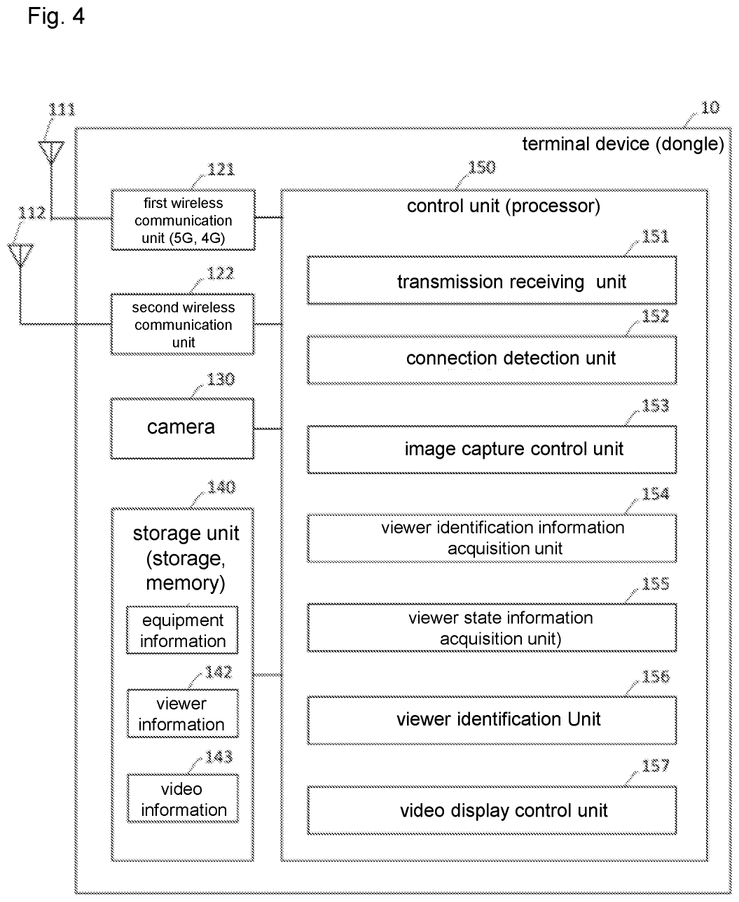

FIG. 4 shows a block diagram of the functional configuration of the terminal device 10 comprising the screen presentation system 1. As shown in FIG. 4, the terminal device 10 comprises a plurality of antennas (an antenna 111, an antenna 112), wireless communication units corresponding to each antenna (first wireless communication unit 121, second wireless communication unit 122), the camera 130, a storage unit 140 and a control unit 150. The terminal device 10 also has functions and configurations not specifically illustrated in FIG. 2 (e.g., a battery for holding power, a power supply circuit for controlling the supply of power from the battery to each circuit, etc.). As shown in FIG. 2, each block included in the terminal device 10 is electrically connected by a bus or other means.

The antenna 111 radiates signals emitted by the terminal device 10 as radio waves. The antenna 111 also receives radio waves from the space and gives the received signals to the first wireless communication unit 121.

The antenna 112 radiates signals emitted by the terminal device 10 as radio waves. The antenna 112 also receives radio waves from the space and gives the received signals to the second wireless communication unit 122.

The first wireless communication unit 121 performs modulation and demodulation processing, etc. for transmitting and receiving signals via the antenna 111 in order for the terminal device 10 to communicate with other wireless devices. The second wireless communication unit 122 performs modulation and demodulation processing, etc. for transmitting and receiving signals via the antenna 112 in order for the terminal device 10 to communicate with other wireless devices. The first wireless communication unit 121 and the second wireless communication unit 122 are communication modules including tuners, RSSI (Received Signal Strength Indicator) calculation circuits, CRC (Cyclic Redundancy Check) calculation circuits and high frequency circuits. The first wireless communication unit 121 and the second wireless communication unit 122 perform modulation and frequency conversion of the radio signals transmitted and received by the terminal device 10 and provide the received signals to the control unit 150.

The camera 130 is a device for receiving light with a light receiving element and outputting it as a captured image. The camera 130 is, for example, a depth camera capable of detecting the distance from the camera 130 to the object being photographed.

The storage unit 140 comprises, for example, a flash memory and stores data and programs used by the terminal device 10. In one aspect, the storage unit 140 stores equipment information 141, viewer information 142 and video information 143.

The equipment information 141 is information on the equipment of the terminal device 10. The equipment information includes information that identifies the terminal device 10 registered on the server 20 (equipment ID), device ID, IP address, etc.

The viewer information 142 is information of a user (viewer) who applies to view various videos via the user terminal 30. The viewer information includes information that identifies the viewer registered on the server 20 (viewer ID), the viewer's name, age and gender.

The video information 143 is video information delivered from the server 20 and temporarily stores the received video information.

The control unit 150 controls the operation of the terminal device 10 by reading a program stored in the storage unit 140 and executing the instructions contained in the program. The control unit 150 is, for example, an application that is incorporated or installed in the terminal device 10 in advance. According to the program, the control unit 150 performs as a transmission receiving unit 151, a connection detection unit 152, a photographing control unit 153, a viewer identification information acquisition unit 154, a viewer status information acquisition unit 155, a viewer identification unit 156 and a video display control unit 157.

The transmission receiving unit 151 controls the process by which the terminal device transmits and receives data with external devices, such as the server 20, according to a communication protocol.

The connection detection unit 152 controls the process of detecting connection of the terminal device 10 to a display device such as a television receiver or the display. Specifically, when the connector 14 of the terminal device 10 is connected to the external connection port of the display device and becomes ready for communication, the connection detection unit 152 detects a signal transmitted from the display device or a response signal to a signal transmitted to the display device. Thereby, the connection detection unit 152 detects that the terminal device is connected to the display device and ready for communication.

The photographing control unit 153 controls the process of photographing the viewer by the camera 130. For example, when the connection detection unit 152 detects the connection of the terminal device to the display device, the photographing control unit 153 activates the camera 130, causes the camera 130 to take pictures of the surroundings of the display device and generates the photographed image information. Furthermore, the photographing control unit 153 moves the camera 130 in the photographing direction. When a person is detected in the photographing image, the control unit controls the camera to continue photographing the person as a viewer. A person may be detected by a human sensor (illustration omitted) provided by the terminal device 10, and the camera 130 may be controlled to continue photographing by moving the photographing direction of the camera 130 in the direction of the detected person.

The viewer identification information acquisition unit 154 controls the process of the server 20 to transmit information that identifies the viewer who has applied for video viewing to the server 20. The viewer identification information is, for example, identification information such as a code number or QR code (registered trademark) transmitted by the server 20 to the user terminal 30 when a viewer makes an application for video viewing at the user terminal 30, to enable authentication that the viewer in question is a viewer who has legitimately applied for video viewing. This is information that enables the viewer to be authenticated as a viewer who has legitimately applied for video viewing.

The viewer identification information may be a facial photograph identifying the viewer's face. For example, when a viewer applies for video viewing at the user terminal 30, the viewer identification information acquisition unit 154 acquires the facial photograph data of the viewer's own face taken at the user terminal 30 in accordance with instructions from the server 20.

Furthermore, the viewer identification information may be information identifying the number of viewers, for example, information on the number of viewers (numerical information), or may be a photograph of the faces of all viewers. For example, the viewer identification information acquisition unit 154 acquires information on the number of persons identified by the viewer when the viewer makes an application for video viewing at the user terminal 30, or the face photograph data of all viewers taken at the user terminal 30 in accordance with instructions from the server 20.

The viewer state information acquisition unit 155 detects the viewer state from the image information of the viewer captured by the camera 130 and controls the process of acquiring the information indicating the viewer state. Information indicating the state of the viewer is, for example, information indicating the direction of the viewer's face when the viewer is in front of the display unit, facial expressions, the viewer's body posture, and whether the viewer is in an awake or asleep state. For example, the information indicating these viewer states is used to determine whether the viewer is in a state in which he or she can view the video.

The acquisition of information indicating the state of the viewer by the viewer state information acquisition unit 155 uses, for example, a known technique of face recognition. This face recognition is performed, for example, by matching an object in the captured image information with a database of face information held as a database not shown, and determining whether it is a face based on the positional relationship between each part, such as eyebrows, eyes, nose and mouth, and the contour of the object. This enables the orientation of the viewer's face to be determined.

The viewer identification unit 156 controls the process of identifying the viewer captured by the camera 130 as a legitimate viewer who has applied for video viewing to the server 20. For example, if the viewer identification information acquisition unit 154 has acquired a code number or QR code as information identifying the viewer, the viewer identification unit 156 causes the code number or QR code to be presented to the viewer via the user terminal 30 so that the information can be captured by the camera 130 and read. If the information read matches the information obtained, the viewer is authenticated as a viewer who has legitimately applied for video viewing.

When the viewer identification information acquiring unit 154 has acquired the viewer's facial photograph as information identifying the viewer, the viewer identification unit 156 instructs the viewer via the user terminal 30 to face the front and detects the viewer's face from the captured image information generated by the photographing control unit 153. If the acquired viewer's face photograph and the viewer's face detected from the captured image information match, the viewer is authenticated as a viewer who has legitimately applied for video viewing. At this time, the viewer identification unit 156 may, use the known technique of face recognition, or the viewer's status by the viewer status information acquisition unit 155. Furthermore, the viewer identification unit 156 may, extract a feature value (first feature value) of the viewer's face in the acquired viewer's face photograph (viewer image information), extract a feature value (second feature value) of the viewer's face detected from the captured image information, and if the respective feature values match a predetermined value or a predetermined percentage or more, authenticate the viewer as the viewer.

Furthermore, if the viewer identification information acquiring unit 154 acquires information identifying the number of viewers as information identifying the viewers, the viewer identification unit 156 instructs the viewers (whether some or all) to face the front via the user terminals 30 and the shooting image generated by the photographing control unit 153. If the number of viewers acquired is compared with the number of viewer faces detected from the captured image information and they match, the viewer identification unit 156 authenticates that all the viewers are legitimate viewers. Even if the number of viewers detected from the captured image information is less than the number of viewers acquired, it may still authenticate that all such viewers are legitimate viewers, because the number of viewers is at least not more than the number of viewers authorized to view the image.

The identification of the viewer by the viewer identification unit 156 may be performed by the server 20. In this case, the captured image information may be transmitted to the server and the terminal device 10 may not have the viewer identification information acquisition unit 154 and the viewer identification unit 156 as functions of the terminal device 10.

The video display control unit 157 receives video information transmitted from the server 20 and controls the process of showing (displaying) various images as video on the display device. For example, the video may be displayed only when the viewer identification unit 156 can identify that the viewer captured by the camera 130 is a legitimate viewer. The video may be displayed only when information indicating the viewer's status is determined by the viewer status information acquisition unit 155 to be in a state where the viewer is able to view the video.

For example, by equipping the terminal device 10 with a sound output device such as a speaker, the video display control unit 157 may be configured to receive the video information transmitted from the server 20, cause images to be shown (displayed) on a display device and cause sound to be output from a sound output device. For example, by setting the sound output device of the terminal device 10 to a state suitable for viewing the video, it is possible to view the video with higher quality sound.

<1.2. Functional Configuration of the Server 20>

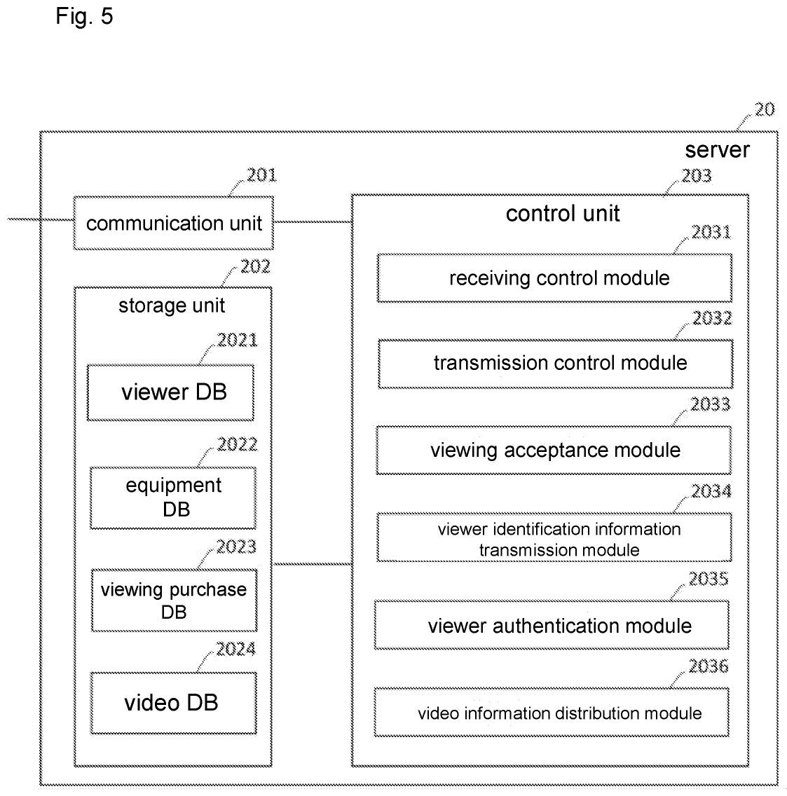

FIG. 5 shows the functional configuration of the server 20 comprising the screen presentation system 1 of the Embodiment 1. As shown in FIG. 5, the server 20 functions as a communication unit 201, a storage unit 202 and a control unit 203.

The communication unit 201 processes the server 20 to communicate with external devices.

The storage unit 202 stores data and programs used by the server 20. The storage unit 202 stores a viewer database 2021, an equipment database 2022, a viewing purchase database 2023, a video database 2024, etc.

The viewer database 2021 is a database for holding information on users (viewers) who view various videos in the screen presentation system 1. Details are described below.

The equipment database 2022 is a database for holding information on the equipment of the terminal device 10 used in the screen presentation system 1. Details are described later.

The viewing purchase database 2023 is a database for holding information on the rights (tickets) to view images purchased by users (viewers) to view various images using the screen presentation system 1. Details are described later.

The video database 2024 is a database for holding video information to be shown (displayed) in the screen presentation system 1. This video information is information on the video to be displayed on a display device such as a television via the terminal device 10. The server 20 does not need to hold the actual video information as the video database 2024, for example, it may be managed by another server and hold only link information to that server.

The control unit 203 performs as the various modules as the program cause processor of the server 20 to execute processing. The various modules comprise a receiving control module 2031, a transmission control module 2032, a viewing acceptance module 2033, a viewer identification information transmission module 2034, a viewer authentication module 2035 and a video information distribution module 2036.

The receiving control module 2031 controls the process by which the server 20 receives signals from external devices according to a communication protocol.

The transmission control module 2032 controls the process by which the server 20 transmits signals to external devices according to a communication protocol.

The viewing acceptance module 2033 controls the process of accepting the application for viewing the video when the viewer makes an application for viewing the video at the user terminal 30. The viewing acceptance module 2033, for example, transmits to the user terminal 30 selectable information such as the type of video available for viewing (e.g., the genre and category), the title of the video, the available viewing time and the ticket price, and presents this information to the viewer. The viewer operates the user terminals 30 and selects from among the presented images, and the viewing acceptance module 2033 receives the information on the selected image. The server 20 then processes the sending of the terminal device 10 to the viewer.

The viewer identification information transmission module 2034 controls the process of transmitting viewer identification information as a response to the transmission request from the viewer identification information acquisition unit 154 of the terminal device 10, which transmits a transmission request for information identifying the viewer who has applied for video viewing. The viewer identification information includes, as described above, identification information such as a code number or QR code, a facial photograph identifying the viewer's face, and information identifying the number of viewers, such as headcount information and facial photographs of all multiple viewers.

The viewer authentication module 2035 controls the process of authenticating that the viewer filmed by the camera 130 of the terminal device 10 is a legitimate viewer who has applied to the server 20 for video viewing. The authentication performed by the viewer authentication module 2035 is the same as the authentication of the viewer performed by the viewer identification unit 156 of the terminal device 10, and when such function is performed by the terminal device 10, the viewer authentication module 2035 need not be provided as a function of the server 20.

The video information distribution module 2036 controls the process of distributing video information to the terminal device 10 of a viewer who applied to view the video. The video information distribution module 2036 may be configured to deliver the video information to a specific viewer according to the viewer information stored in the viewer database 2021. Specifically, the information may be delivered only to viewers whose attributes, such as viewer gender and age, are specific (e.g., women in their 20s, etc.), or only to viewers at a specific address (e.g., Tokyo, or Kansai region, etc.). Furthermore, the video information distribution module 2036 may be configured to distribute advertisement information (e.g., distributing advertisements for youth-oriented automobiles to males in their 20s to 30s, etc.) to specific viewers according to viewer information stored in the viewer database 2021. The advertising information may be still images or video.

### 2. Data Structure

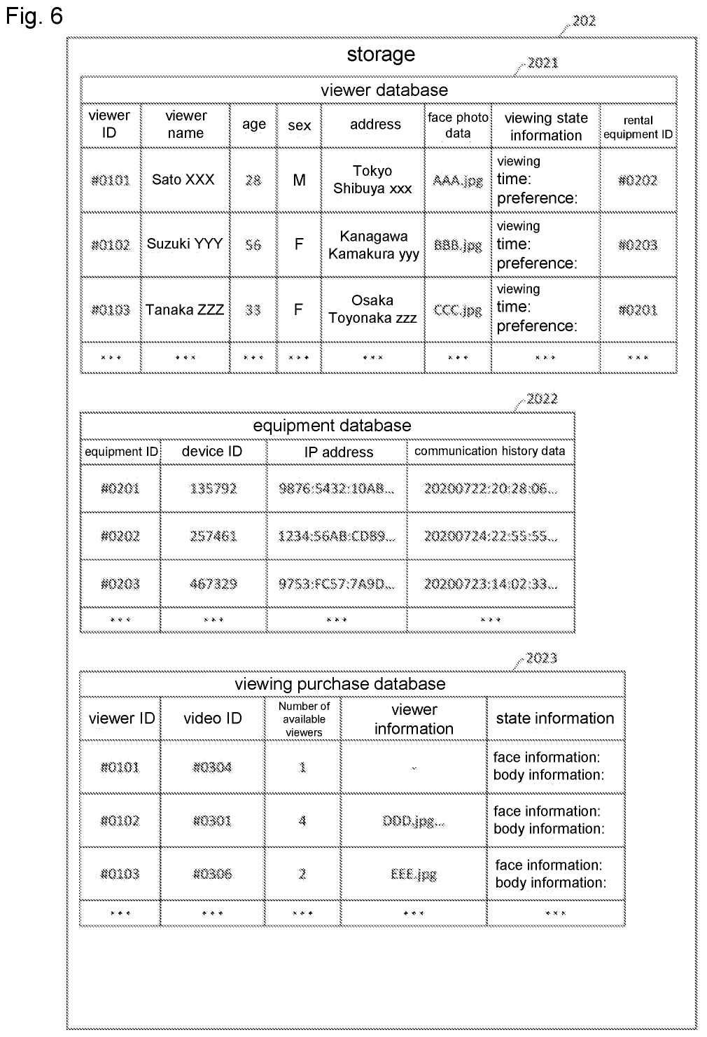

FIG. 6 shows the data structure of the viewer database 2021, equipment database 2022 and viewing purchase database 2023 stored by the server 20.

As shown in FIG. 6, each of the records in the viewer database 2021 includes the item “viewer ID”, the item “viewer name”, the item “age”, the item “sex”, the item “address”, the item “face photo data”, the item “viewing status information”, the item “rental equipment ID”.

The item “viewer ID” is information that identifies each viewer who has applied for video viewing. The operation of the screen presentation system 1 may require membership registration to apply for video viewing, in which case the information may be used to identify each member.

The item “viewer name” is information indicating the name of the viewer who applied for video viewing.

The item “age” is information indicating the age of the viewer who applied for video viewing.

The item “sex” indicates the gender of the viewer who applied to view the video.

The item “address” indicates the address of the viewer who applied for video viewing.

The item “face photo data” is photo data that identifies the face of the viewer who made the application to view the video.

The item “viewing status information” is the analysis information of the viewer who has applied for video viewing, based on which the viewer's video viewing is analyzed. The analysis of viewers is described below.

The item “rental equipment ID” is information that identifies each of the 10 terminals loaned to viewers who have applied for video viewing.

Each of the records in the equipment database 2022 includes the item “equipment ID,” the item “device ID,” the item “IP address,” the item “communication history data,”.

The item “equipment ID” is information that identifies each of the terminal devices 10 lent to viewers who have applied for video viewing and corresponds to the item “device ID” in the viewer database 2021.

The item “device ID” is information for identifying the terminal device 10 and is information for identifying individual devices assigned by the device manufacturer.

The item “IP address” is the address information of each of the terminal device 10, which is necessary when communicating with the terminal device 10 via the internet.

The item “communication history data” is the history information of communication with the terminal device 10 and is used to determine whether communication with the terminal device 10 was successful or not and is used as maintenance information for the terminal device 10.

Each of the records in the viewing purchase database 2023 includes the item “viewer ID,” the item “video ID,” the item “number of available viewers,” the item “viewer information,” the item “state information,”.

The item “viewer ID” identifies each viewer who has applied to view the video and corresponds to the item “viewer ID” in the viewer database 2021.

The item “video ID” is information that identifies each of the image information pertaining to the image and corresponds to the item “video ID” that identifies each of the image information in the video database 2024 (illustration omitted).

The item “number of available viewers” is information that identifies the number of viewers who have applied for video viewing and is information on the number of viewers specified by the viewer (from among those presented by server 20) when the viewer applies for video viewing at the user terminal 30.

The item “viewer information” is information that identifies viewers other than the viewer who applied for video viewing when the item “number of viewers available” is multiple. For example, photo data that identifies the viewer's face is stored, similar to the item “face photo data” in the viewer database 2021.

The item “state information” is information indicating the state of the viewer. Specifically, for example, it is information indicating the viewer's facial orientation when the viewer is in front of the display device, facial expressions, the viewer's body posture, and whether the viewer is in a wakeful or sleep state.

When the viewing acceptance module 2033 receives an application for video viewing from a viewer, the application information is stored in the viewing purchase database 2023.

### 3 Operation

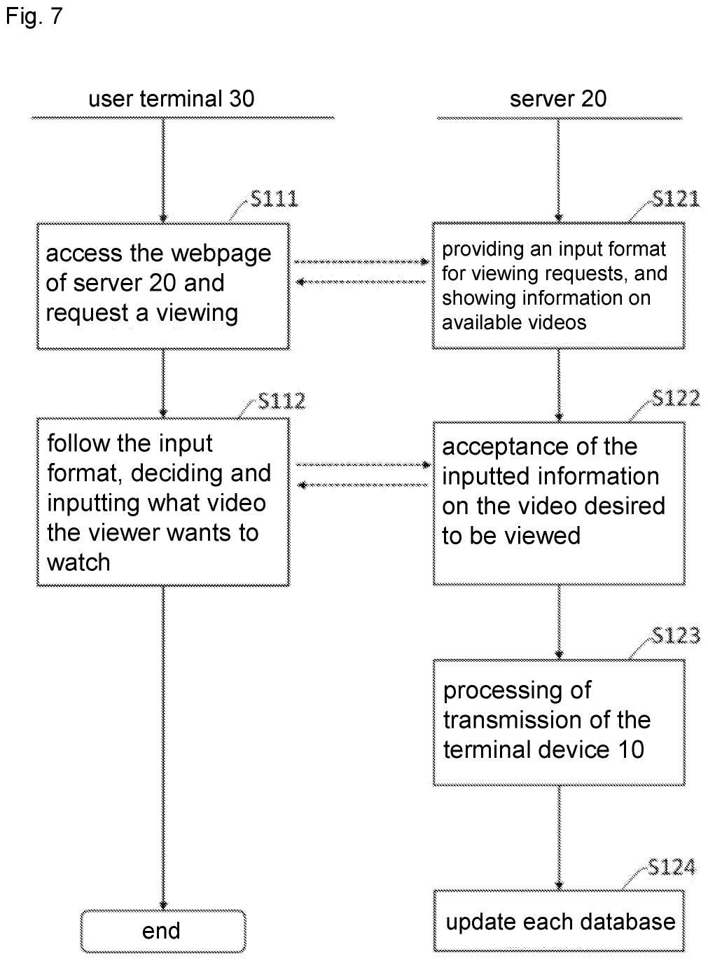

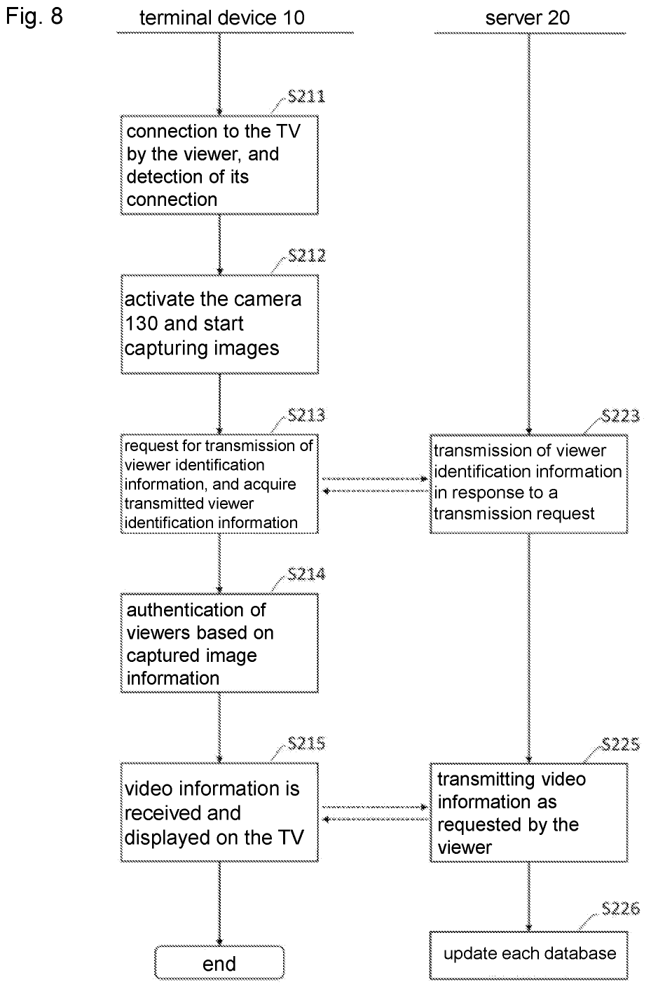

The following describes the video screening process by the video screen presentation system 1 in the Embodiment 1 with reference to FIG. 7 and FIG. 8.

FIG. 7 is a flowchart showing an example of the flow of the video viewing application acceptance process by the screen presentation system 1 of the Embodiment 1.

In step S111, the input device 33 of the user terminal 30 receives an input operation of user information from the user to use the service of the screen presentation system 1. For example, the user refers to a web page provided by the server 20 and operates to enter the user's identification information (viewer ID) and password. The communication IF 32 transmits the user's identification information and password information to the server 20. The operation of the screen presentation system 1 may be require membership registration for video viewing. In this case, if the user is not registered as a member, the user's personal information is required to be entered on the web page for membership registration.

In step S121, the viewing acceptance module 2033 of the server 20 accepts the user's identification information and password information transmitted from the terminal device 10 via the communication unit 201. The viewing acceptance module 2033 transmits to the accepted user's user terminal 30, via the communication unit 201, information on a list of images that can be viewed, information on the start date and time of viewing of each image and the price of the ticket, and an input format when the user wishes to view one of these images.

In step S112, the communication IF 32 of the user terminals 30 accepts the list information of viewable images transmitted from the server 20, information such as the start date and time of viewing, and the input format. The output device 34 of the user terminals 30 displays the accepted input format on the screen. The input device 33 of the user terminals 30 accepts the input operation of the application for video viewing by the user from the displayed input format. The communication IF 32 transmits the application information for video viewing to the server 20.

In step S122, the viewing acceptance module 2033 of the server 20 accepts the request information for video viewing transmitted from the terminal device 10 via the communication unit 201.

In step S123, the server 20 sends the terminal device 10 to the user who made the application and whose application information for video viewing was received in step S122. The terminal device 10 does not necessarily be sent each time to a user who applied to view the video. If the user already possesses the terminal device 10, this step can be omitted.

In step S124, the viewing acceptance module 2033 of the server 20 stores the user information received in step S121 in the viewer database 2021. In addition, the viewing acceptance module 2033 performs the process of storing the video viewing application information received in step S122 in the viewing purchase database 2023.

As described above, in the embodiment of screen presentation system 1, when the user applies to view the video, the terminal device 10 is sent to the user. When the user receives the terminal device 10, user connects it to own television set, as described below.

FIG. 8 is a flowchart showing an example of the flow of the video screening process by the screen presentation system 1 of the Embodiment 1.

In step S211, the user (viewer) who has made an application to view the video connects the connector 14 of the terminal device 10 sent by the operator of the server 20 to the user's own display device. The connection detection unit 152 of the terminal device 10 detects that the connector 14 of the terminal device 10 is connected to the display device. When the connector 14 is connected to the external connection port, the display device send a detection signal (or a response signal to the signal sent by the terminal device 10 to the display device) and the connection detection unit 152 detects that the connector 14 of the terminal device 10 is connected to the display device by the received signal.

In step S212, the photographing control unit 153 of the terminal device 10 activates the camera 130 when the connection of the terminal device to the display device is detected in step S211 and causes the camera 130 to photograph the surroundings of the display device to generate the photographing image information. For example, when the photographing control unit 153 detects a person from the photographed image, it controls the photographing to continue with the photographed person as a viewer.

In step S213, the viewer identification information acquisition unit 154 of the terminal device 10 performs a process of transmitting to the server 20 and acquiring information identifying a viewer who has made an application for video viewing to the server 20. The viewer identification information acquisition unit 154 causes information identifying the viewer to be transmitted to the server 20 via the transmission receiving unit 151 and acquires information identifying the viewer by a response from the server 20.

In step S223, the viewer identification information transmission module 2034 of the server 20 transmits information identifying the viewer in response to the transmission request from the terminal device 10 in step S213. The viewer identification information transmission module 2034 transmits, as viewer identification information such as a code number or QR code, a facial photograph identifying a viewer's face, headcount information as information identifying the number of viewers and a facial photograph of all viewers of a plurality of viewers via communication unit 201.

In step S214, the viewer identification unit 156 of the terminal device 10 identifies, from the image information of the viewer photograph by the camera 130 that started taking pictures in step S212, that the viewer taken is a legitimate viewer who has applied to request to the server 20 to view the video viewing. If the information identifying the viewer is a code number or QR code, the viewer identification unit 156 presents the code number or QR code so that the viewer can be photographed by the camera 130, so that the information is read and judged to match. In addition, when the information identifying the viewer is a facial photograph identifying the viewer's face, the viewer identification unit 156 detects the viewer's face from the captured image information and determines whether it matches. When the information identifying the viewer is information identifying the number of viewers, the viewer identification unit 156 detects the viewer's face from the captured image information and determines whether it matches (or is less than or equal to) the permitted number of viewers.

In step S225, the video information distribution module 2036 of the server 20 distributes the video information pertaining to the video to the terminal device 10 of the viewer who made the application for video viewing. The video information distribution module 2036 transmits the video information to the terminal device 10 via the communication unit 201.

In step S215, the video display control unit 157 of the terminal device 10 receives the video information transmitted from the server 20 in step S225 and processes the various images to be shown (displayed) on the display device as video images. At this time, the video display control unit 157 causes the various images to be shown (displayed) on the display device only when it is authenticated in step S214 that the viewer photographed by the camera 130 is a legitimate viewer who has made an application to the server 20 for video viewing.

In step S226, the server 20 stores information (illustration omitted) to the effect that the viewer who made an application for video viewing has viewed the video in the viewing purchase database 2023.

As described above, in the embodiment of the screen presentation system 1, when the viewer applies to view the video, the terminal device is sent to the viewer, and when the viewer connects the terminal device to the user's own display device, the viewer is authorized and the video is displayed on the display device. This prevents unauthorized use and makes it possible to construct a video distribution system that can be easily use.

### 4. Screen Example

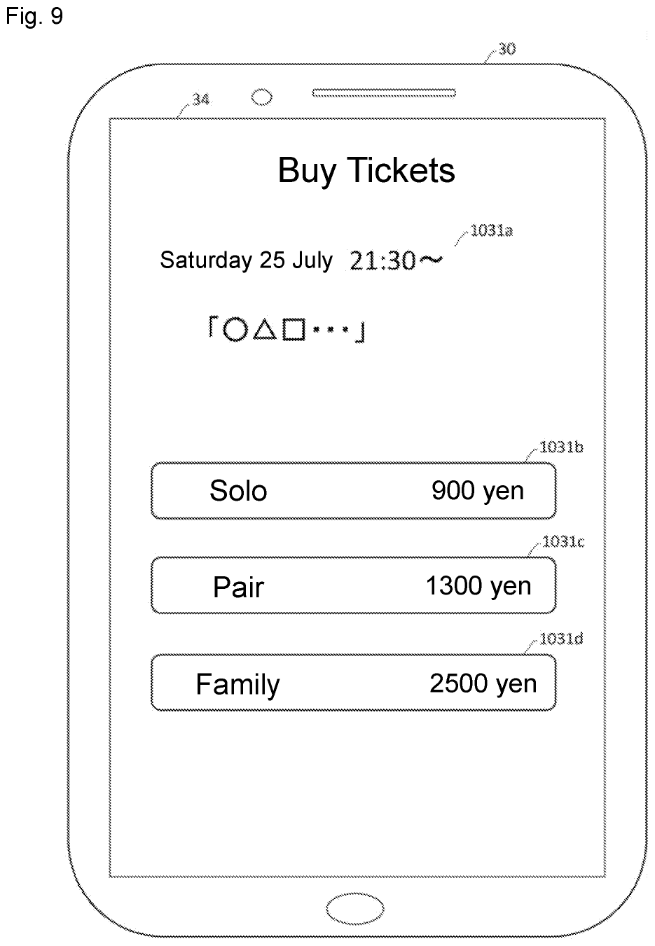

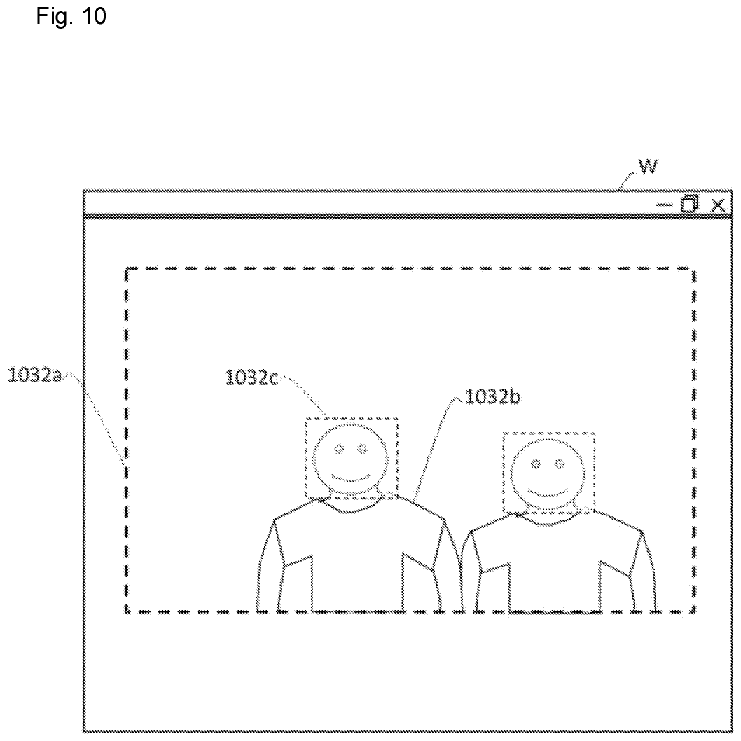

The screen examples of the video screening process by the screen presentation system 1 are described below, with reference to FIG. 9 and FIG. 10.

FIG. 9 shows an example screen displaying application information on the user terminal in the video viewing application acceptance process. The screen example in FIG. 9 shows a screen example in which information on one video is selected from the list of available video information and the input operation of the application for video viewing by the user is performed from the displayed input format. It corresponds to step S112 of FIG. 7.

As shown in FIG. 9, information on the video selected by the user is displayed on the output device (display) 34 of the user terminal 30. In the example of FIG. 9, there is information on a video screening date and time 1031a and selection buttons 1031b to 1031d that allow the user to select the number of people who can view the video and the price of the ticket for that number of people. For example, “Solo” displayed on the selection button 1031b indicates that one viewer can view the video, “Pair” displayed on the selection button 1031c indicates that two viewers can view the video, and “Family” displayed on the selection button 1031d indicates that four viewers can view the video. The user selects one of the selection buttons 1031b to 1031d and presses it by tapping, etc. to enable viewing of the selected video.

FIG. 10 shows an example of a state in which a viewer is filmed by the camera 130 of the terminal device 10 in the video screening process. The example in FIG. 10 shows an example of the filmed image information, in which a person is filmed by the camera 130 as a viewer under the control of the photographing control unit 153. This is the captured image information according to step S212 of FIG. 8.

As shown in FIG. 10, a frame 1032a, which is a shooting range by the camera 130, is displayed in a window W, which shows an example of the shot image information by the camera 130 on a given PC or the like. The frame 1032a is displayed with the viewer 1032b captured and the viewer's face 1032c recognized. Recognition of the face 1032c is performed by a known technique of face recognition, as described above. In order to authenticate that the viewer 1032b is a viewer who has made a legitimate application for video viewing, authentication is carried out, as described above, for example, by a feature extraction process.

<Brief Summary>

As described above, according to this Embodiment, when a user request to view the video, a terminal device is sent to the user, and when the terminal device is connected to the user's display device, video information is distributed and the video is displayed on the display device. This makes it possible to easily use the video distribution system and view the video.

When the user connects the terminal device to the user's own display device, the viewer is photographed and the viewer is authenticated, and the video is displayed on the display device only when the viewer is authenticated to be a legitimate viewer. This makes it possible to prevent unauthorized use in the video distribution system.

### Embodiment 2

Another Embodiment of the screen presentation system 1 is described below.

<1. Overall Configuration of the Screen Presentation System 1>

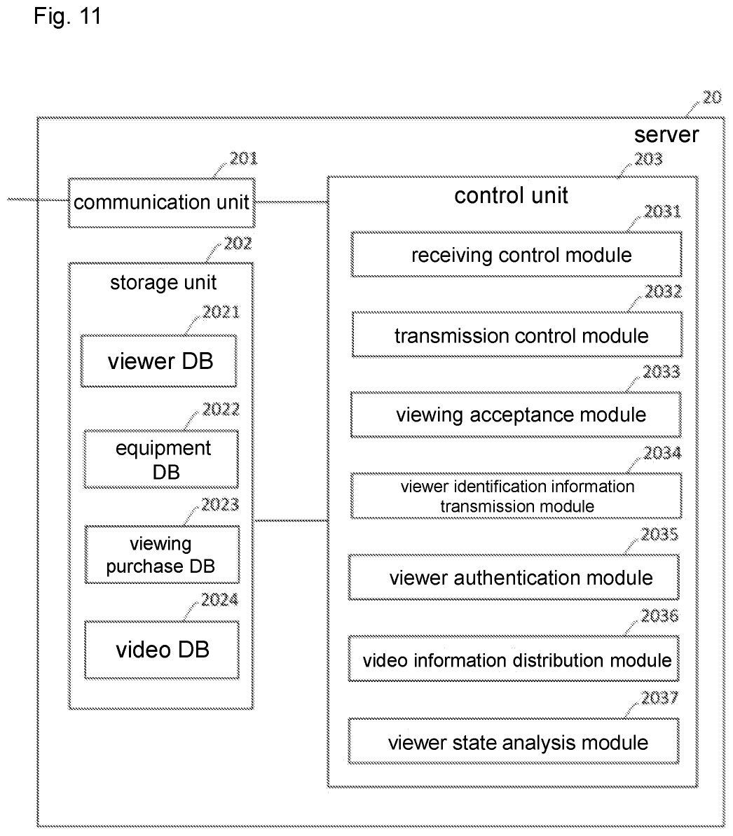

FIG. 11 shows the functional configuration of the server 20 that constitutes the screen presentation system 1 in the Embodiment 2. The overall configuration of the screen presentation system 1 in the Embodiment 2 and the configuration of the terminal unit 10 are similar to those of the Embodiment 1 and will not be explained repeatedly. The configuration of the server 20 is similar to the Embodiment 1, except that it is newly equipped with a viewer state analysis module 2037 function, as shown in FIG. 11. The functions of the viewer state analysis module 2037 in the Embodiment 2 are described below.

The viewer state analysis module 2037 controls the process of analyzing and obtaining information indicating the viewer's viewing state based on information indicating the viewer's state by the viewer state information acquisition unit 155. The objects to be analyzed by the viewer state information acquisition unit 155 are, specifically, the direction of the viewer's face, the viewer's facial expression, and the viewer's body posture and motion, which are analyzed by image analysis. Information indicating the viewer's viewing state is, for example, the viewer's emotions, the viewer's degree of concentration on the image, and the viewer's degree of satisfaction with the image, such as whether the viewer is concentrating on viewing the image by looking in the direction of the display unit or not concentrating on viewing the image by looking in another direction or frequently moving his/her body (i.e. the viewer is not concentrating on viewing the image by looking in another direction or moving his/her body). The viewer is judged according to whether he or she is not concentrating on viewing the image (i.e. bored with viewing the image) by looking in other directions or moving his or her body frequently. From the information indicating the state of the viewer, whether the viewer is temporarily out of the picture (e.g. temporarily leaving the seat to go to the bathroom) or whether the viewer is out of the picture for a long period of time (i.e. has stopped viewing due to other business, etc.) are also be detected. The results of these analyses are recorded as the viewer's preference information for the video, and can be used to evaluate the video, recommend the video to the viewer and select the video to be provided by the operator.

The method of analyzing the orientation of the face by the viewer state analysis module 2037 may use the known technique of face recognition, escribed above. The method of analyzing facial expressions by the viewer state analysis module 2037 is, for example, a known method such as the Facial Action Coding System (FACS). This FACS is a method in which a code called an action unit is assigned to each facial expression muscle, and the emotion at that time is identified in response to the intensity and balance of the action unit that changes in response to the movement of the facial expression muscle and is an artificial intelligence technology for recognizing human emotions. This enables to identify the emotions of the viewer.

Information indicating the viewer's viewing state by the viewer state analysis module 2037 is acquired, for example, by quantifying the movement of the viewer's face changing direction, the viewer's facial expression, the viewer's body posture and the number and size of movements respectively.

As a example, the number of movements that change the direction of the viewer's face, the number of movements that change the viewer's body posture and the number of movements per predetermined time is calculated. Here, it is known empirically that when a person is concentrating on something, the number of face orientation and body movements tends to decrease. Therefore, it is possible to estimate the viewer's degree of concentration by analyzing the frequency of facial orientation and body movements. This enables to obtain information indicating the degree of concentration on the video image.

As another example, the degree of eye opening and the number of eye blinking at a given time are calculated. Here, it is known empirically that when a person is concentrating on something, the opening of the eyes tends to increase, and the number of eye blinking decreases. Therefore, it is considered possible to estimate the viewer's degree of concentration by analyzing the degree of eye opening and the frequency of the number of blinks per predetermined time. This enables to obtain information indicating the degree of concentration on the video image.

As another example, the degree of concentration may be calculated by performing predetermined operations on the movements of the viewer's face changing direction, the movements of the viewer's body changing posture, the degree of eye opening and the number of eye blinking per predetermined time, respectively, and adding the respective values after the operations. Furthermore, information indicating satisfaction with the images may be calculated from the information indicating the degree of concentration on the images. As the degree of satisfaction with the images is considered to be proportional to the degree of concentration on the images, the degree of concentration on the images may be regarded as the degree of satisfaction with the images, and the degree of satisfaction with the images may be calculated by performing a predetermined calculation on the degree of concentration on the images, taking the viewer's emotions into account.

<2. Data Structure>

The data structure in the Embodiment 2 is the same as that of the Embodiment 1.

<3. Operation>

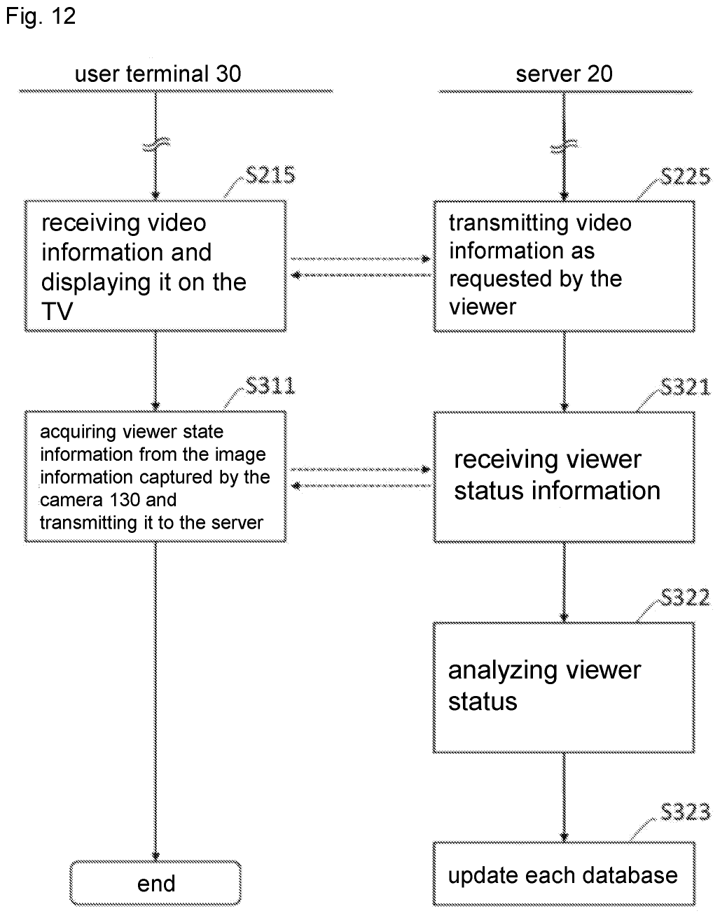

The screening process of images by the screen presentation system 1 in the Embodiment 2 is described below, with reference to FIG. 12.

FIG. 12 is a flowchart showing an example of the flow of the screening process of video images by the screen presentation system 1 of the Embodiment 2. The video screening process in the flowchart shown in FIG. 12 adds steps S311, S321, S322 and S323 as subsequent processes to steps S215 and S225 of the video screening process in the flowchart shown in FIG. 8, so that overlapping processes will not be repeated and explained. In the flowchart shown in FIG. 12, steps S211 to S214 and step S223 are omitted.

In step S311, the viewer state information acquiring unit 155 of the terminal device 10 detects the viewer state from the image information of the viewer captured by the camera 130 and acquire the information indicating the viewer state. The viewer state information acquiring unit 155 also processes the information indicating the viewer state to be sent to the server 20 via the transmission receiving unit 151.

In step S321, the viewer state analysis module 2037 of the server 20 receives the information indicating the viewer state transmitted from the terminal device 10 via the communication unit 201.

In step S322, the viewer state analysis module 2037 of the server 20 carries out an analysis based on the information indicating the viewer state accepted in step S321 and obtains information indicating the viewer's viewing state.

In step S323, the viewer state analysis module 2037 of the server 20 processes storing the information indicating the viewer state accepted in step S321 to the viewing purchase database 2023. The viewer state analysis module 2037 also processes storing information on the results of the analysis performed in step S322 to the viewer database 2021.

As described above, in the embodiment of the screen presentation system 1, when a viewer views a video, the camera 130 of the terminal device 10 takes a picture of the viewer and obtains information indicating the viewer's state. Based on this information indicating the viewer's state, analysis is performed and information indicating the viewer's viewing state is acquired. This information is recorded as the viewer's preference information for images and can be used for recommending images to the viewer and selecting images to be provided by the operator concerned.

<Brief Summary>

As described above, according to this Embodiment, when a viewer watches a video, the viewer is filmed and information indicating the viewer's state is acquired. Based on this information indicating the viewer's state, analysis is performed and information indicating the viewer's viewing state is obtained. This information is recorded as viewer preference information for the viewer's images and can be used for recommending images to the viewer and selecting images to be provided by the operator concerned.

### Embodiment 3

Another Embodiment of the screen presentation system 1 is described below.

<1. Overall Configuration of the Screen Presentation System 1>

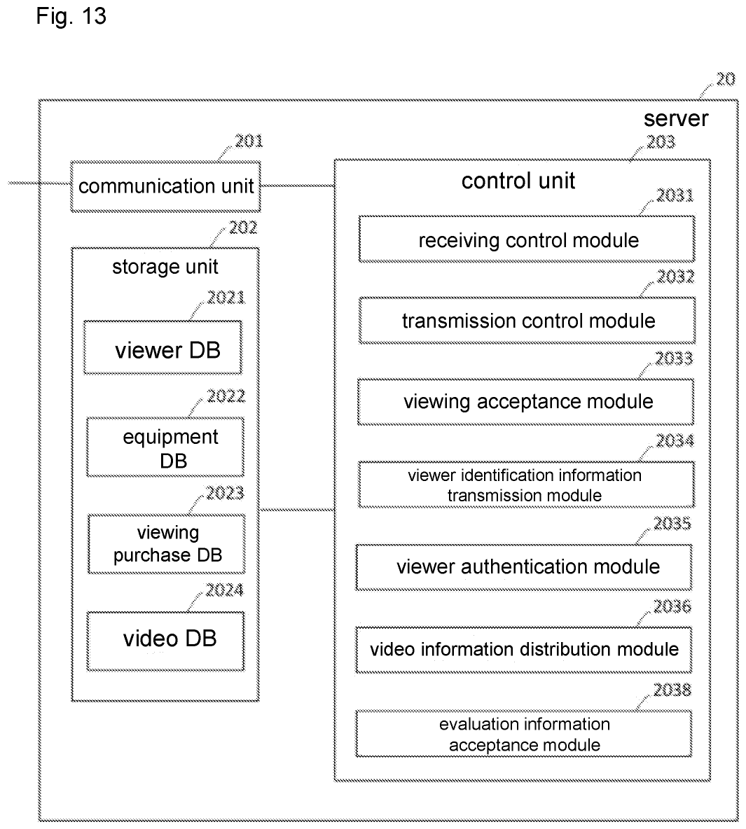

FIG. 13 shows the functional configuration of the server 20 that constitutes the screen presentation system 1 of the Embodiment 3. The overall configuration of the screen presentation system 1 in the Embodiment 3 and the configuration of the terminal unit 10 are similar to those of the Embodiment 1 and will not be explained repeatedly. The configuration of the server 20 is similar to that of the Embodiment 1, except that it is newly equipped with a function of the evaluation information acceptance module 2038, as shown in FIG. 13. The function of the evaluation information acceptance module 2038 in the Embodiment 3 is described below.

The evaluation information acceptance module 2038 controls the process of accepting the evaluation information sent by the viewer on the user terminals 30, when the viewer sends evaluation information on the viewed video. The evaluation information transmitted by the viewer is, for example, information indicating the viewer's impression of the viewed video as interesting, enjoyable, boring or tedious, and may be information in the form of free descriptions in text format, or a numerical value of the evaluation, for example, one of 1 to 5 in a 5-level evaluation. This evaluation information is sent to the producers, performers, etc. who produced the video. Furthermore, the evaluation information may be an item with monetary value that can be sent to the producers, performers, etc. who produced the video in accordance with the evaluation of the video. Here, the item with monetary value may be a cash settlement information, credit information, various point information and cryptographic assets that can be settled in the same way as cash.

<Brief Summary>

As described above, according to this Embodiment, when a viewer watches a video, the viewer sends evaluation information for the video, which is accepted. This evaluation information is transmitted to the producers, performers, etc. who produced the vide. This enables the feedback of the viewer's impressions to the producers, etc. If the evaluation information is something that has monetary value, it is possible to provide an item with a monetary value to the producers of the good video in the form of so-called throwaway money or a small tip.

The Embodiments pertaining to the disclosure have been described above. They can be implemented in various other forms, and can be implemented with various omissions, substitutions, and changes. These Embodiments and variations, as well as omissions, substitutions, and modifications, are included within the technical scope of the claims and their equivalents.

### APPENDIX

The matters described in each of the above-mentioned forms are appended below.

### Appendix 1

A terminal device connected to a display device displaying video comprising a control unit and a photographing unit; wherein the photographing unit captures an image of a viewer viewing the video displayed on the display device and generates captured image information; and wherein the control unit executes a step of detecting the connection of the terminal device to the display device; a step of acquiring information indicating a state of the viewer based on the captured image information; and a step of receiving video information distributed from an external source and displaying the video on the display device based on the state of the viewer.

### Appendix 2

The terminal device according to appendix 1, wherein the control unit is configured to execute a step of detecting a state in which the viewer is ready to view the video based on the captured image information and acquiring information indicating the viewer's state, and a step of starting the display of the video on the display device when the state in which the viewer is ready to view the video.

### Appendix 3

The terminal device according to appendix 2, wherein the terminal device is configured to detect that the viewer is ready to view the video by detecting at least one of the following in the captured image information: the viewer's facial direction and facial expression, the viewer's posture, and the viewer's awake state.

### Appendix 4

The terminal device according to any one of appendixes 1 to 3, wherein the control unit is further configured to execute a step of acquiring information from an external source identifying the viewer allowed to view the video, and a step of starting the display of the video on the display device when the viewer is identified as a person allowed to view the video by a predetermined authentication based on the information identifying the viewer.

### Appendix 5

The terminal device according to appendix 4, wherein the information identifying the viewer as a person allowed to view the video is transmitted by the viewer from an external device, and when the terminal device receives the information transmitted by the viewer, the predetermined authentication is performed and the terminal device executes the step of starting the display of the video on the display device.

### Appendix 6

The terminal device according to appendix 4 or appendix 5, wherein the control unit is configured to execute a step of detecting the viewer based on the captured image information, and a step of starting the display of the video on the display device when the viewer detected on the basis of the captured image information is authenticated as a person allowed to view the video, as a predetermined authentication.

### Appendix 7

The terminal device according to appendix 6, wherein the control unit is configured to execute a step of acquiring viewer image information identifying the face of the viewer allowed viewing the video, a step of detecting the face of the viewer based on the captured image information, and a step of starting the display of the video on the display device when the detected viewer is authenticated as a person allowed to view the video based on a comparison of the viewer's image information and the viewer's face in the captured image information.

### Appendix 8

The terminal device according to appendix 7, wherein the control unit is configured to execute, in the step of detecting the viewer's face, extracting a first feature quantity of the viewer's face in the viewer image information, and extracting a second feature quantity of the viewer's face in the viewer image information and comparing the first feature quantity and the second feature quantity, and if they match a predetermined value or a predetermined percentage or more, authenticating that the detected viewer is a person allowed to view the video, and starting to display the video on the display device.

### Appendix 9

The terminal device according to any one of appendixes 6 to 8, wherein the control unit is configured to execute a step of acquiring information identifying the number of viewers allowed to view the video, a step of detecting the number of viewers based on the captured image information, and a step of starting the display of the video on the display device when the detected number of viewers is authenticated to be less than or equal to the number of persons allowed to view the video.

### Appendix 10

The terminal device according to any one of appendixes 1 to 9, wherein the control unit is configured to execute a step of detecting the viewer when viewing the video based on the captured image information and a step of acquiring information indicating the viewer's viewing state based on the viewer's state in the captured image information.

### Appendix 11

The terminal device according to appendix 10, wherein the terminal device is configured to execute a step of detecting the face of the viewer when viewing the video based on the captured image information, a step of analyzing the facial expression of the viewer in the captured image information, and a step of acquiring information indicating the viewing state of the viewer.

### Appendix 12

The terminal device according to appendix 10 or appendix 11, wherein the terminal device is configured to execute a step of detecting the body motion of the viewer when viewing the video based on the captured image information, a step of analyzing the viewer's body motion in the captured image information, and a step of acquiring information indicating the viewer's viewing state.

### Appendix 13

The terminal device according to any one of appendixes 10 to 12, wherein the terminal device is configured to execute a step of acquiring, as information indicating the viewing state of the viewer, information indicating at least one of the following states: the viewer's emotion, the viewer's degree of concentration on the video, or the viewer's degree of satisfaction with the video.

### Appendix 14

The terminal device according to any one of appendixes 1 to 13, wherein the control unit is configured to execute a step of receiving video information distributed from external sources, a step of displaying the image of the video on the display device, and a step of outputting the sound of to the video.

### Appendix 15

The terminal device according to any one of appendixes 1 to 14, wherein the control unit is configured to execute a step of accepting evaluation information on the video from the viewer.

### Appendix 16

A method for execution by a computer provided with a processor and connected to a display device displaying video, wherein the method comprises a processor executing a step of detecting the connection of the terminal device to the display device; a step of capturing a viewer viewing the video displayed on the display device and generating the captured image information; a step of acquiring information indicating a state of the viewer based on the captured image information; and a step of receiving video information distributed from an external source and displaying the video on the display device on the state of the viewer.

### Appendix 17

A program for execution by a computer provided with a processor and connected to a display device displaying video, wherein the program is configured to cause the processor to execute a step of detecting the connection of the terminal device to the display device; a step of capturing a viewer viewing the video displayed on the display device and generating the captured image information; a step of acquiring information indicating a state of the viewer based on the captured image information; and a step of receiving image information related to the image delivered from an external source based on the information indicating the state of the viewer, and displaying the image on the said display device.
10 terminal device
20 server
30 user terminals
80 network
130 camera
140 storage unit
141 equipment information
142 viewer information
143 video information
150 control unit
22 communication IF
23 input/output IF
25 memory
26 storage
29 processor
201 communication unit
202 storage unit
2021 viewer database
2022 equipment database
2023 viewing purchase database
2024 video database
203 control unit

1. A terminal device connected to a display device displaying video comprising a control unit and a photographing unit;
wherein the photographing unit captures an image of a viewer viewing the video displayed on the display device and generates captured image information; and
wherein the control unit executes
detecting the connection of the terminal device to the display device;
acquiring information from an external source identifying the number of viewer allowed to view the video;
detecting the number of viewers based on the captured image information;
acquiring information indicating a state of the viewer based on the captured image information; and
starting the display of the video on the display device when the detected number of viewers is authenticated to be less than or equal to the number of persons allowed to view the video.

2. The terminal device according to claim 1, wherein the control unit is configured to execute
acquiring information indicating a state of the viewer based on the captured image information before the viewer views the video;
determining that the viewer is ready to view the video based on the information indicating the state of the viewer; and
receiving the video information distributed from the external source and starting to display the video on the display device, when the viewer is ready to view the video.

3. The terminal device according to claim 2, wherein the terminal device is configured to detect that the viewer is ready to view the video by detecting at least one of the following in the captured image information: the viewer's facial direction and facial expression, the viewer's posture, and the viewer's awake state.

4. The terminal device according to claim 1, wherein the control unit is further configured to execute
acquiring information from an external source identifying the viewer allowed to view the video, and
starting the display of the video on the display device when the viewer is identified as a person allowed to view the video by a predetermined authentication based on the information identifying the viewer.

5. The terminal device according to claim 4, wherein an information identifying the viewer as a person allowed to view the video is transmitted by the viewer from an external device, and when the terminal device receives the information transmitted by the viewer, the predetermined authentication is performed and the terminal device executes the step of starting the display of the video on the display device.

6. The terminal device according to claim 4, wherein the control unit is configured to execute
detecting the viewer based on the captured image information, and
starting the display of the video on the display device when the viewer detected on the basis of the captured image information is authenticated as a person allowed to view the video, as a predetermined authentication.

7. The terminal device according to claim 6, wherein the control unit is configured to execute
acquiring viewer image information identifying the face of the viewer allowed viewing the video,
detecting the face of the viewer based on the captured image information, and
starting the display of the video on the display device when the detected viewer is authenticated as a person allowed to view the video based on a comparison of the viewer's image information and the viewer's face in the captured image information.

8. The terminal device according to claim 7, wherein the control unit is configured to execute, in the step of detecting the viewer's face, extracting a first feature quantity of the viewer's face in the viewer image information, and extracting a second feature quantity of the viewer's face in the viewer image information and comparing the first feature quantity and the second feature quantity, and if they match a predetermined value or a predetermined percentage or more, authenticating that the detected viewer is a person allowed to view the video, and starting to display the video on the display device.

9. (canceled)

10. The terminal device according to claim 1, wherein the control unit is configured to execute
detecting the viewer when viewing the video based on the captured image information and
acquiring information indicating the viewer's viewing state based on the viewer's state in the captured image information.

11. The terminal device according to claim 10, wherein the terminal device is configured to execute
detecting the face of the viewer when viewing the video based on the captured image information,
a step of analyzing the facial expression of the viewer in the captured image information, and
acquiring information indicating the viewing state of the viewer.

12. The terminal device according to claim 10, wherein the terminal device is configured to execute
detecting the body motion of the viewer when viewing the video based on the captured image information,
analyzing the viewer's body motion in the captured image information, and
acquiring information indicating the viewer's viewing state.

13. The terminal device according to claim 10, wherein the terminal device is configured to execute acquiring, as information indicating the viewing state of the viewer, information indicating at least one of the following states: the viewer's emotion, the viewer's degree of concentration on the video, or the viewer's degree of satisfaction with the video.

14. The terminal device according to claim 1, wherein the control unit is configured to execute
receiving video information distributed from external sources,
displaying the image of the video on the display device, and
outputting the sound of to the video.

15. The terminal device according to claim 1, wherein the control unit is configured to execute the step of accepting evaluation information on the video from the viewer.

16. A method for execution by a computer provided with a processor and connected to a display device displaying video,
wherein the method comprises a processor executing
detecting the connection of the terminal device to the display device;
acquiring information from the external source that identifying the number of viewers authorized to view the video;
capturing a viewer viewing the video displayed on the display device and generating the captured image information;
detecting the number of viewers based on the captured image information;
acquiring information indicating a state of the viewer based on the captured image information; and
receiving video information distributed from an external source and displaying the video on the display device on the state of the viewer.

17. A non-transitory computer-readable storage medium storing a program for executing by a computer provided with a processor and connected to a display device displaying video,
wherein the program is configured to cause the processor to execute
detecting the connection of the terminal device to the display device;
acquiring information from the external source that identifying the number of viewers authorized to view the video;
capturing a viewer viewing the video displayed on the display device and generating the captured image information;
detecting the number of viewers based on the captured image information;
acquiring information indicating a state of the viewer based on the captured image information; and
receiving image information related to the image delivered from an external source based on the information indicating the state of the viewer, and displaying the image on the said display device.
